(19) United States
(12) Patent Application Publication
(10) Pub. No.: US 2025/0076460 A1
(43) Pub. Date: Mar. 6, 2025

(54) SYSTEMS AND METHODS FOR LINEAR FREQUENCY-MODULATED CONTINUOUS-WAVE (LFMCW) RADAR

(71) Applicant: Intelligent Fusion Technology, Inc., Germantown, MD (US)

(72) Inventors: Genshe CHEN, Germantown, MD (US); Xing Ping LIN, Germantown, MD (US); Bora SUL, Germantown, MD (US); Erik BLASCH, Arlington, VA (US); Khanh PHAM, Kirtland AFB, NM (US); Ping ZHUANG, Germantown, MD (US); Yunqi ZHANG, Germantown, MD (US); Hua-Mei CHEN, Germantown, MD (US)

(21) Appl. No.: 18/461,825

(22) Filed: Sep. 6, 2023

(51) Int. Cl. G01S 7/35; G01S 13/933

(52) U.S. Cl. CPC G01S 7/358; G01S 7/354; G01S 13/933

(57) ABSTRACT

A radar system includes a signal generator for generating an LFMCW signal, an intermediate frequency (IF) signal generator for generating an IF signal, an upper converter for increasing the frequency of the LFMCW signal by the IF to generate a radar signal, a mixer for decreasing the frequency of a received radar signal to generate an output signal, an IQ demodulator for decreasing the frequency of the output signal to generate a baseband signal, an analog-to-digital converter for transforming the baseband signal into a digital signal, and a micro controller for processing the digital signal.

### GOVERNMENT RIGHTS

This invention was made with Government support under Contract No. W15QKN-19-C-0048, awarded by the United States Army. The U.S. Government has certain rights in the present disclosure.

### TECHNICAL FIELD

The present disclosure generally relates to the field of radar technology and, more particularly, relates to linear frequency-modulated continuous-wave (LFMCW) radars and airborne LFMCW radars.

### BACKGROUND

Linear frequency-modulated continuous-wave (LFMCW) radars have high precision, good range resolution, good directivity, and low transmitting power. LFMCW radars can be mounted on a vehicle or an airplane for high-precision detections, such as velocity, range, and position measurements. However, for small and light unmanned aerial vehicles (UAVs), traditional LFMCW radars are still too heavy and consume too much power.

UAVs have found a wide range of applications, such as aerial surveillance, package delivery, search and rescue, pollution monitoring, agriculture, photography, and filming. Meanwhile, there is an increase of security incidents involving malicious UAVs and threats from malicious UAVs, e.g., around airports. Many UAVs have a small size, mostly made of plastic, and can fly close to terrain. They have inherent stealth capabilities due to a very small radar cross-section. While a malicious UAV poses a significant challenge to conventional ground radar systems, it can be detected by an airborne LFMCW radar mounted on a UAV that is sent to the sky and relatively closer to the malicious UAV. As such, airborne LFMCW radars with high sensitivity, light weight, small size, and low power consumption are highly desirable. The disclosed systems and methods are directed to solve one or more problems set forth above and other problems.

### BRIEF SUMMARY OF THE DISCLOSURE

In one aspect of the present disclosure, a radar system operates at a low intermediate frequency (IF) range to reduce the power consumption, ground clutter, and interference signals. The radar system is composed of one transmitting channel and at least one receiving channel. The radar system includes the following components: an LFMCW signal generator for generating an LFMCW signal; a frequency synthesizer and a frequency divider for generating an IF signal; an upper converter using the IF for increasing the frequency of the LFMCW signal to generate a radar signal; a transmitting antenna for transmitting the radar signal; a receiving antenna for receiving a reflected radar signal; a mixer for decreasing the frequency of the reflected radar signal to generate an output signal; an in-phase/quadrature phase demodulator (IQ demodulator) for decreasing the frequency of the output signal to generate a baseband signal; an analog-to-digital converter (ADC) for transforming the baseband signal into a digital signal; and a micro controller for processing the digital signal. The frequency of the radar signal is a sum of the frequency of the LFMCW signal and the IF.

In another aspect of the present disclosure, a method for a radar includes generating an LFMCW signal by an LFMCW signal generator, generating an IF signal using a frequency synthesizer, increasing the frequency of the LFMCW signal to generate a radar signal by an upper converter, transmitting the radar signal by a transmitting antenna, receiving a reflected radar signal by a receiving antenna, decreasing the frequency of the reflected radar signal to generate an output signal by a mixer, decreasing the frequency of the output signal to generate a baseband signal by an IQ demodulator, transforming the baseband signal into a digital signal by an ADC, and processing the digital signal by a micro controller. The frequency of the radar signal is a sum of the frequency of the LFMCW signal and the IF.

In another aspect of the present disclosure, a UAV includes a flight controller, a communication module, an LFMCW signal generator for generating an LFMCW signal, an IF signal generator for generating an IF signal, an upper converter for increasing the frequency of the LFMCW signal to generate a radar signal, a transmitting antenna for transmitting the radar signal, a receiving antenna for receiving a reflected radar signal, a mixer for decreasing the frequency of the reflected radar signal to generate an output signal, an IQ demodulator for decreasing the frequency of the output signal to generate a baseband signal, an ADC for transforming the baseband signal into a digital signal, and a micro controller for processing the digital signal. The frequency of the radar signal is a sum of the frequency of the LFMCW signal and the IF.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a diagram illustrating an exemplary LFMCW radar structure in accordance with various embodiments of the present disclosure;

FIG. 2 is a diagram illustrating an exemplary LFMCW radar structure with two receiving channels in accordance with various embodiments of the present disclosure;

FIG. 3 is a diagram illustrating an exemplary UAV structure with an airborne LFMCW radar in accordance with various embodiments of the present disclosure;

FIG. 4 is a diagram illustrating an exemplary UAV structure with an airborne LFMCW radar in accordance with various embodiments of the present disclosure; and

FIG. 5 illustrates an exemplary method for LFMCW radars in accordance with various embodiments of the present disclosure.

### DETAILED DESCRIPTION

Reference will now be made in detail to exemplary embodiments of the disclosure, which are illustrated in the accompanying drawings.

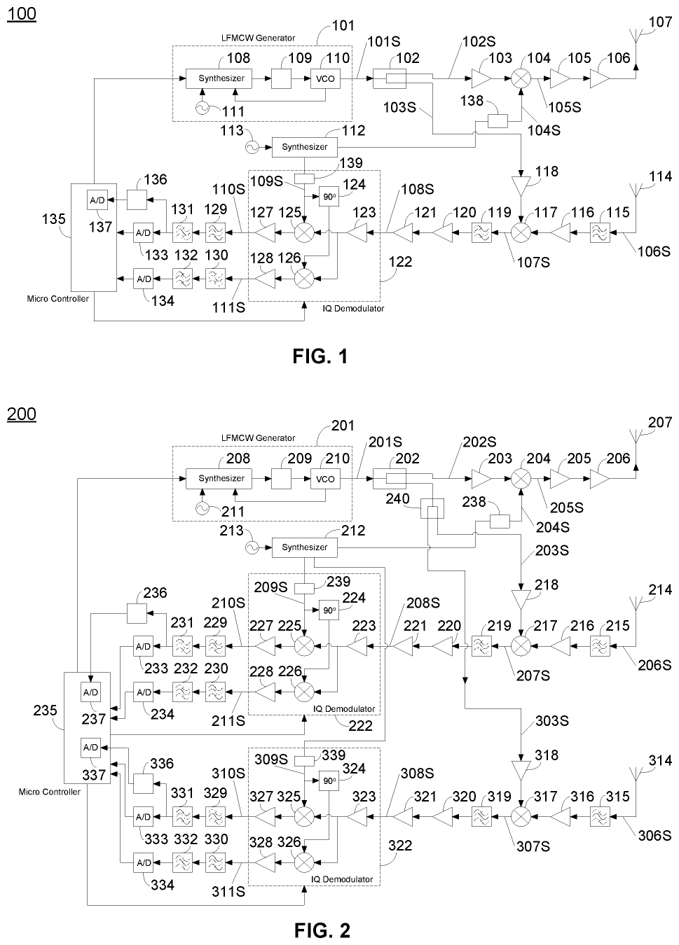

FIG. 1 shows a diagram of an exemplary structure of an LFMCW radar 100 according to the present disclosure. The radar or radar structure may also be referred to as a radar system. The LFMCW radar 100 is low in size, weight, power, and cost (SWaP-C) and may be mounted on a small UAV to detect other UAVs.

The LFMCW radar 100 includes a transmitting channel to transmit signals to a target and a receiving channel to receive and process signals reflected by the target. The transmitting channel may include components such as an LFMCW signal generator 101, a power divider 102, a first amplifier 103, an upper converter 104, an amplifier driver 105, a second amplifier 106, a transmitting antenna 107, and a frequency divider 138. These components are connected with one another directly or indirectly. The LFMCW signal generator 101 may include a first frequency synthesizer 108 (e.g., the Analog Devices ADF4159 frequency synthesizer), a loop filter 109, a voltage-controlled oscillator (VCO) 110, and a first frequency reference 111. Optionally, the power divider 102 may be replaced by a directional coupler. Both the power divider and the directional coupler may be referred to as a power splitting component that splits an input signal into multiple output signals.

The receiving channel may include components such as a second frequency synthesizer 112, a second frequency reference 113, a receiving antenna 114, a bandpass filter 115, a third amplifier 116, a first mixer 117, and a fourth amplifier 118. The components in the receiving channel are connected with one another directly or indirectly. The third amplifier 116 is a low noise amplifier. Optionally, the transmitting and receiving antennas 107 and 114 may be Yagi antennas, helical antennas, horn antennas, or patch antennas. The patch antennas may include patch array antennas. In descriptions below, exemplary transmitting and receiving antennas are low-profile patch array antennas.

In the transmitting channel as shown in FIG. 1, the LFMCW signal generator 101 may generate an LFMCW signal 101S with a frequency of f(t). The signal 101S is split into two parts, i.e., signals 102S and 103S, by the power divider 102. In some embodiments, the power level of the signal 102S may be similar to that of the signal 103S. Optionally, the power level of the signal 102S may be higher or much higher than that of the signal 103S. The signal 102S may be amplified by the first amplifier 103. The arrows in FIG. 1 indicate directions signals are transmitted or directed along.

The amplified signal 102S and a signal 104S are inputted into the upper converter 104. The frequency of the amplified signal 102S is f(t). The signal 104S is generated by the frequency divider 138 that divides an input frequency by 2. The second frequency reference 113 generates a reference signal that is sent to the second frequency synthesizer 112. The second frequency synthesizer 112, connected to and controlled by a micro controller 135, utilizes the reference signal to produce a signal with twice the IF and sends the signal to the frequency divider 138. As such, the frequency of the signal 104S is IF and the signal 104S may be referred to as an IF signal. The second frequency synthesizer 112, the second frequency reference 113, and the frequency divider 138 together form an IF signal generator. In some cases, the IF may be in a frequency range of 400 to 1000 MHz exemplarily, or even lower. The upper converter 104 increases the frequency of the amplified signal 102S by the IF to generate a signal 105S. As such, the signal 105S has a frequency that is a sum of f(t) and the IF. Thereafter, the signal 105S may be amplified by the second amplifier 106. The amplified signal 105S is sent to the transmitting antenna 107 and may be considered as the radar signal. The radar signal is transmitted to the target by the transmitting antenna 107. In some cases, the frequency of the radar signal may be in the X-band, e.g., between 8 to 12 GHz.

In the receiving channel, the receiving antenna 114 obtains a signal 106S. The signal 106S represents a reflected radar signal coming from the target. The signal 106S is filtered by the bandpass filter 115 and then amplified by the third amplifier 116. The amplified signal 106S is inputted into the first mixer 117. As aforementioned, the LFMCW signal 101S is divided into two parts and one of them is the signal 103S. The signal 103S may be used as the local oscillator signal and amplified by the fourth amplifier 118. The amplified signal 103S is transmitted and fed to the first mixer 117. The amplified signal 106S and amplified signal 103S are mixed at the first mixer 117, which may be referred to as a down converter that performs frequency down conversion. The first mixer 117 decreases the frequency of the amplified signal 106S to generate an output signal 107S. Optionally, the frequency of the output signal 107S may be around the IF.

The receiving channel may further include components such as a filter 119, a fifth amplifier 120, a sixth amplifier 121, and an IQ demodulator 122. Optionally, the filter 119 may be a narrowband filter with the IF as the center frequency. In some cases, the bandwidth of the filter 119 may be 200 KHz. The fifth amplifier 120 may be a low noise IF amplifier and the sixth amplifier 121 may be an ultrahigh frequency (UHF) amplifier. The signal 107S is filtered by the filter 119 that removes undesired side bands and image frequencies. The signal 107S is then amplified by the fifth and sixth amplifiers 120 and 121, respectively. The amplified signal 107S becomes a signal 108S that is inputted into the IQ demodulator 122.

The IQ demodulator 122 contains a seventh amplifier 123, a 90-degree phase shifter 124, a second mixer 125, a third mixer 126, an eighth amplifier 127, a ninth amplifier 128, and a frequency divider 139. The eighth and ninth amplifiers 127 and 128 are IF amplifiers. Referring to the second synthesizer 112 mentioned above, besides transmitting the signal to the frequency divider 138, the second synthesizer 112 also transmits another signal to the frequency divider 139 that divides an input frequency by 2 to generate an IF signal 109S. The IF signal 109S is utilized by the IQ demodulator 122 for down conversion. The IQ demodulator 122 amplifies the signal 108S by the seventh amplifier 123, and then demodulates the amplified signal 108S by the IF signal 109S. The IQ demodulator 122 uses the second and third mixers 125 and 126 and the eighth and ninth amplifiers 127 and 128 to down convert (or reduce) the frequencies of and amplify the in-phase and quadrature phase components of the signal 108S, respectively. As a result of the demodulation and amplification, baseband signals 110S and 111S are generated. That is, the IQ demodulator 122 decreases the frequency of the signal 108S and converts the signal 108S into baseband signals 110S and 111S. As the IF used at the upper converter 104 and IQ demodulator 122 (for down conversion) is originated from the same source, the second frequency reference 113, the synchronization is maintained. In some aspects, the frequency of the baseband signals 110S and 111S may be below 120 KHz exemplarily.

The receiving channel may further include components such as bandpass filters 129, 130, 131, and 132, ADCs 133 and 134, and an ADC selection 136. The baseband signal 110S is filtered by the filters 129 and 131 before being inputted into the ADC 133. The baseband signal 111S is filtered by the filters 130 and 132 before being inputted into the ADC 134. Optionally, the filters 129 and 130 may be high-pass filters that remove low frequency components of the signals and minimize the transmission leakage into the receiving channel and nearby object interference (e.g., in the low frequency range), while the filters 131 and 132 may be low-pass filters that remove certain high frequency components of the signals, which include the blocker and far distance ground clutter. The ADCs 133 and 134 convert the baseband signals 110S and 111S to digital signals for subsequent data processing at the micro controller 135. Optionally, the micro controller 135 may contain an ADC 137. In some cases, the baseband signal 110S may be directed to the ADC 137 by the ADC selection 136 after being filtered by the filters 129 and 131. The ADC 137 then transforms the filtered baseband signal 110S into a digital signal for further processing at the micro controller 135.

The LFMCW radar 100 may transmit a low-power radar signal, and use the narrowband IF filter 119 to obtain a low receiver noise floor (or high receiver sensitivity) to compensate the low transmitting power. The advantage of the LFMCW radar 100 may include that it requires lower power to transmit radar signals compared to conventional LFMCW radars, and it achieves a relatively good working range since it may integrate the energy over a longer time window than a pulse radar does.

As illustrated above, the upper converter 104 shifts the frequency of the LFMCW signal 101S (or the signal 102S) higher by the IF to generate the radar signal 105S. In the meantime, part of the LFMCW signal 101S is used as the local oscillator signal 103S for the first mixer 117. The local oscillator signal 103S is mixed with the reflected radar signal 106S. This mixing of the signals occurs at the IF offset frequency from the instantaneous output of the first frequency synthesizer 108. At this IF offset frequency, the phase noise of the first frequency synthesizer 108 may be much lower than that at locations near its operation frequency. In addition, some of the radar signal 105S may be received by the receiving antenna 114 and feedback into the receiving channel as the leakage. The leakage may be mixed with signals with low phase noise at the IF offset from the operating frequency of the frequency synthesizer 108. This may result in a low level of mixed leakage signals down to the receiving channel after the first mixer 117. The high-pass filters 129 and 130 and narrowband IF filter 119 after the mixer 117 may further reduce the residual leakage.

In some embodiments, the baseband signals 110S and 111S may have low frequency. As such, the sampling frequency of the ADCs 133 and 134 and the power consumption of the micro controller 135 may be reduced. Optionally, the filters 131 and 132 may be 8th order low-pass filters with sharp rejection of the outside band interference and clutter, which may enhance the high analog sensitivity of the LFMCW radar 100. In some embodiments, the low-pass filters 131 and 132 may be adjustable and have a programmable cutoff frequency. As such, the micro controller 135 may control the cutoff frequency. In some cases, the cutoff frequency of the low-pass filters 131 and 132 may be 20, 40, or 80 KHz exemplarily. The programmable cutoff frequency may reduce the noise and far distance ground clutter, providing a low-noise floor for the ADCs 133 and 134 to capture low-level signals buried in white noise as well as range zone gate control. Optionally, post processing may be implemented by the micro controller 135. Alternatively, post processing may be implemented by a computer outside the radar 100. Further, there may be a significant processing gain after signals are processed by fast Fourier transformation (FFT) over a specified window of time.

FIG. 2 shows a diagram of an exemplary structure of an LFMCW radar 200 according to the present disclosure. Like the radar 100, the LFMCW radar 200 has low SWAP-C features and may be mounted on a small UAV to detect other UAVs.

In some embodiments, the LFMCW radar 200 may include a transmitting channel to transmit signals to a target and multiple receiving channels to receive and process signals reflected by the target, respectively. For example, the radar 200 may have a first receiving channel and a second receiving channel. The transmitting channel of the radar 200 may have a similar structure and similar functions to that of the transmitting channel of the radar 100. The first and second receiving channels each may have a similar structure and similar functions to that of the receiving channel of the radar 100. The first and second receiving channels may be similar with respect to the structure and functions.

The transmitting channel may include components such as an LFMCW signal generator 201, a power divider 202, an amplifier 203, an upper converter 204, an amplifier driver 205, an amplifier 206, a transmitting antenna 207, a frequency divider 238, and a power divider 240. The power dividers 202 and 240 may be replaced by directional couplers in some cases. The components in the transmitting channel are connected with one another directly or indirectly. The LFMCW signal generator 201 may include a frequency synthesizer 208, a loop filter 209, a VCO 210, and a frequency reference 211.

The first receiving channel may include a frequency synthesizer 212, a frequency reference 213, a receiving antenna 214, a bandpass filter 215, an amplifier 216, a mixer 217, and an amplifier 218. The components in the first receiving channel are connected with one another directly or indirectly. The amplifier 216 is a low noise amplifier.

The second receiving channel may include a receiving antenna 314, a bandpass filter 315, an amplifier 316, a mixer 317, and an amplifier 318. The components in the second receiving channel are connected with one another directly or indirectly. The amplifier 316 is a low noise amplifier. The transmitting antenna 207 and receiving antennas 214 and 314 are low-profile patch array antennas exemplarily.

In the transmitting channel as shown in FIG. 2, the LFMCW signal generator 201 generates an LFMCW signal 201S with a frequency of f(t). The signal 201S is split into two parts. One part of the signal 201S becomes a signal 202S, while the other part is split into signals 203S and 303S by the power divider 240. In some embodiments, the power level of the signal 202S may be similar to that of the signal 203S and 303S. Optionally, the power level of the signal 202S may be higher or much higher than that of the signal 203S and 303S. The power levels of the signals 203S and 303S may be similar. The signal 202S may be amplified by the amplifier 203. The arrows in FIG. 2 indicate directions signals are transmitted or directed along.

The amplified signal 202S and a signal 204S are inputted into the upper converter 204. The frequency of the amplified signal 202S is f(t). The signal 204S is generated by the frequency divider 238 that divides an input frequency by 2. The frequency reference 213 generates a reference signal that is sent to the frequency synthesizer 212. The frequency synthesizer 212 utilizes the reference signal to produce a signal with twice the IF and transmits the signal to the frequency divider 218. Thus, the frequency of the signal 204S is IF and the signal 204S may be referred to as an IF signal. The upper converter 204 increases the frequency of the amplified signal 202S by the IF to generate a signal 205S. As such, the signal 205S has a frequency that is a sum of f(t) and the IF. Thereafter, the signal 205S may be amplified by the amplifier 206. The amplified signal 205S is sent to the transmitting antenna 207 and may be considered as the radar signal. The radar signal is transmitted to the target by the transmitting antenna 207.

In the first receiving channel, the receiving antenna 214 obtains a signal 206S. The signal 206S is a reflected radar signal received by the antenna 214. The signal 206S is filtered by the bandpass filter 215 and then amplified by the amplifier 216. The amplified signal 206S is inputted into the mixer 217. The signal 203S, as a portion of the LFMCW signal 201S, may be used as the local oscillator signal and amplified by the amplifier 218. The amplified signal 203S is transmitted to the mixer 217. The amplified signal 206S and amplified signal 203S are mixed at the mixer 217. The mixer 217 decreases the frequency of the amplified signal 206S to generate an output signal 207S. The frequency of the output signal 207S may be around the IF.

In the second receiving channel, the receiving antenna 314 obtains a signal 306S. The signal 306S is a reflected radar signal received by the antenna 314. The signal 306S is filtered by the bandpass filter 315 and then amplified by the amplifier 316. The amplified signal 306S is inputted into the mixer 317. The signal 303S, as a portion of the LFMCW signal 201S, may be used as the local oscillator signal and amplified by the amplifier 318. The amplified signal 303S is transmitted to the mixer 317. The amplified signal 306S and amplified signal 303S are mixed at the mixer 317. The mixer 317 decreases the frequency of the amplified signal 306S to generate an output signal 307S. The frequency of the output signal 307S may be around the IF.

The first and second receiving channels may further include filter 219 and 319, amplifiers 220 and 320, amplifier 221 and 321, and IQ demodulators 222 and 322, respectively. Optionally, the filters 219 and 319 may be narrowband filters with the IF as the center frequency. The amplifiers 220 and 320 may be low noise IF amplifiers. The amplifiers 221 and 321 may be UHF amplifiers. The signals 207S and 307S are respectively filtered by filters 219 and 319, amplified by the amplifiers 220 and 320, and amplified by the amplifiers 221 and 321. The amplified signal 207S becomes a signal 208S that is inputted into the IQ demodulator 222. The amplified signal 307S becomes a signal 308S that is inputted into the IQ demodulator 322.

The IQ demodulator 222 contains an amplifier 223, a 90-degree phase shifter 224, mixers 225 and 226, amplifiers 227 and 228, and a frequency divider 239. The amplifiers 227 and 228 are IF amplifiers. Referring to the second synthesizer 212, besides transmitting the signal to the frequency divider 238, the second synthesizer 212 also transmits another signal to the frequency divider 239 that divides an input frequency by 2 to generate an IF signal 209S. The IF signal 209S is utilized by the IQ demodulator 222. The IQ demodulator 222 amplifies the signal 208S by the amplifier 223, and then demodulates the amplified signal 208S by the IF signal 209S. The IQ demodulator 222 uses the mixers 225 and 226 and the amplifiers 227 and 228 to down convert the frequencies of and amplify the in-phase and quadrature phase components of the signal 208S, respectively. As a result of the demodulation and amplification, baseband signals 210S and 211S are generated.

The IQ demodulator 322 contains an amplifier 323, a 90-degree phase shifter 324, mixers 325 and 326, amplifiers 327 and 328, and a frequency divider 339. The amplifiers 327 and 328 are IF amplifiers. The second synthesizer 212 also transmits another signal to the frequency divider 339 that divides an input frequency by 2 to generate an IF signal 309S. The IF signal 309S is utilized by the IQ demodulator 322. The IQ demodulator 322 amplifies the signal 308S by the amplifier 323, and then demodulates the amplified signal 308S by the IF signal 309S. The IQ demodulator 322 uses the mixers 325 and 326 and the amplifiers 327 and 328 to down convert the frequencies of and amplify the in-phase and quadrature phase components of the signal 308S, respectively. As a result of the demodulation and amplification, baseband signals 310S and 311S are generated.

The first receiving channel may further include bandpass filters 229-232, ADCs 233-234, and an ADC selection 236. The baseband signal 210S is filtered by the filters 229 and 231 before being inputted into the ADC 233. The baseband signal 211S is filtered by the filters 230 and 232 before being inputted into the ADC 234. The filters 229 and 230 may be high-pass filters, while the filters 231 and 232 may be low-pass filters. The ADCs 233 and 234 convert the baseband signals 210S and 211S to digital signals for subsequent data processing at the micro controller 235. Optionally, the micro controller 235 may contain an ADC 237. In some cases, the baseband signal 210S may be directed to the ADC 237 by the ADC selection 236 after being filtered by the filters 229 and 231. The ADC 237 then transforms the filtered baseband signal 210S into a digital signal for further processing at the micro controller 235.

The second receiving channel may further include bandpass filters 329-332, ADCs 333-334, and an ADC selection 336. The baseband signal 310S is filtered by the filters 329 and 331 and then directed to the ADC 333. The baseband signal 311S is filtered by the filters 330 and 332 and then sent to the ADC 334. The filters 329 and 330 may be high-pass filters, while the filters 331 and 332 may be low-pass filters. The ADCs 333 and 334 convert the baseband signals 310S and 311S to digital signals for subsequent data processing at the micro controller 235. Optionally, the micro controller 235 may contain another ADC 337. Optionally, the baseband signal 310S may be directed to the ADC 337 by the ADC selection 336. The ADC 337 then transforms the filtered baseband signal 310S into a digital signal for further processing at the micro controller 235.

In some embodiments, the receiving antennas 214 and 314 may form an antenna array. The antenna array may be used as a smart antenna with smart signal processing algorithms. In some cases, the receiving antennas 214 and 314 may have the same antenna arrangement and same polarization. Results from the first and second receiving channels may be combined to identify a moving direction of a target.

Optionally, the receiving antennas 214 and 314 may have different antenna arrangements and different polarizations. When the antennas have different polarizations, the direction measurement of a target may be improved and the target identification process may also be improved, since signals received by one antenna may be stronger than that received by the other antenna. Further, different polarizations may provide additional measurement parameters and targets may be categorized with different signatures. For example, different polarizations may be used to distinguish between a bird and a small UAV.

In some cases, the receiving antennas 214 and 314 may be combined to expand the coverage angle. For example, one antenna may cover-30 degrees to 0 degree, while the other antenna may cover 0 to 30 degrees. In some aspects, signals of the receiving channels 214 and 314 may be combined by addition to strengthen the signals and improve the detection range.

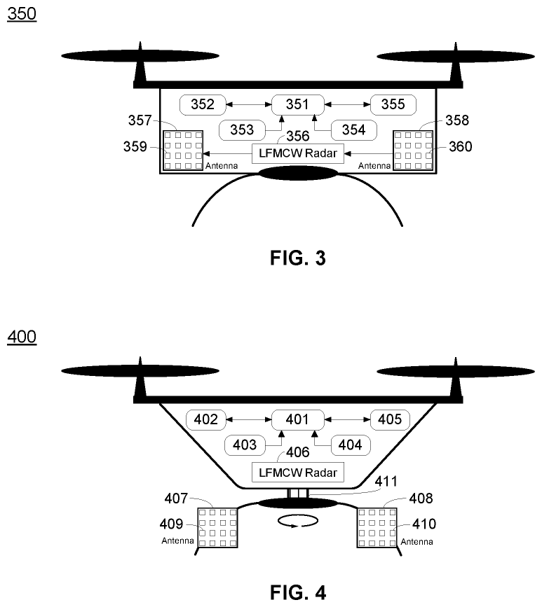

FIG. 3 shows a diagram illustrating an exemplary UAV structure according to the present disclosure. As shown in FIG. 3, a UAV 350 may include a microcontroller unit (MCU) 351, a flight controller 352, a global positioning system (GPS) 353, inertial measurement units (IMUs) 354, a communication module 355, and batteries (not shown). The UAV 350 may also include propellers, rotors, and other parts that are not annotated in the figure. The MCU 351 contains a chip for data processing. The flight controller 352 is responsible for the stable flight of the UAV 350, usually with predefined waypoint navigation. The GPS 353 is used for localization, and the IMUs 354 (e.g., an electronic compass, a gyroscope, a magnetometer, and/or an accelerometer) are utilized to measure flight dynamics such as pitch, yaw and roll angles. The communication module 355 is used to establish communication links between the UAV 350 and ground stations, ground users, or terrestrial base stations. The communication links include both command & control and payload communication links.

Further, the UAV 350 includes an LFMCW radar 356 that may have low SWAP-C characteristics. In some embodiments, the structure of the LFMCW radar 356 may be the same as or similar to that of the LFMCW radar 100 as illustrated in FIG. 1. The LFMCW radar 356 has transmitting and receiving antennas 357 and 358 as illustrated in FIG. 3, while other components of the radar are not shown in the figure. In some embodiments, there may be more receiving antennas with multiple receiving channels. As the transmission leakage into the receiving channel may desensitize the receiver performance, transmitting and receiving antenna nulls may point to each other to reduce the leakage in some cases. Optionally, the mounting planes of transmitting and receiving antennas may be offset. Optionally, the separation between the transmitting and receiving antennas may be arranged so that the leakage is in the opposite phase of the internal LO signal path difference between the transmitting and receiving channels. Optionally, the transmitting and receiving antennas 357 and 358 may be high-gain low-profile patch array antennas and contain patch elements 359 and 360, respectively.

Similar to the LFMCW radar 100, the LFMCW radar 356 may produce an LFMCW signal. The LFMCW signal may be split into a first portion and second portion that are sent to an upper converter and a mixer, respectively. The upper converter increases the frequency of the first portion by the IF to generate a radar signal. The radar signal is transmitted to a target by the transmitting antenna 357. The second portion of the LFMCW signal is used as a local oscillator signal for the mixer to mix with a reflected radar signal.

The reflected radar signal is received by the receiving antenna 358. Optionally, double conversions may be performed in the receiving channel using the mixer, an IQ demodulator, the local oscillator signal, and an IF signal, as described above with respect to FIG. 1. The double conversions are down conversions that provide high image rejection and high rejection of interference signals, strong blocker, and minimize the leakage from the transmitting antenna 357 into the receiving channel. It also improves the noise floor in the receiving channel. In some cases, the reflected radar signal from the target may be amplified first and then mixed with the local oscillator signal in the first down conversion. The output signal of the mixer is a high IF signal. Next, a narrowband filter may remove the outside band signals and keep the noise floor low. The second down conversion is an IF conversion that generates the baseband signal. Thereafter, two filters are used to filter the baseband signal. The first filter is a high-pass filter that may further decrease the noise of the leakage from the transmitting channel to the receiving channel. The second filter is an 8th order low-pass filter with adjustable cut-off frequency. A micro controller of the radar 356 may optionally set the corner at a certain value (e.g., 20, 40, or 60 KHz) based on the ramping rate and range zone. The adjustable high-order low-pass filter may reduce the noise, interference signals, and far distance ground clutter.

In some embodiments, multiple frequency scan rates and different sample sizes may be arranged for different ranges. For example, a faster scan rate with less sample size may be used for a shorter range for quick response, adjusted and improved resolution, fast update rate, and placing the signal beyond the cut off frequency, while a slower scan rate with more sample size and longer integration time window may be used for a longer range for better sensitivity and reduction of close-by objects or ground clutter signals.

In some cases, the detectable target size may be determined by the range. For a short range, the detectable target size may be relatively smaller. For a long range, the detectable target size may be relatively larger.

Optionally, the separation between the transmitting and receiving antennas 357 and 358 may be adjustable. The adjustable distance between the antennas 357 and 358 may be used to reduce the leakage from the antenna 357 to the antenna 358. Optionally, a calibration process may be performed to minimize the transmitting channel leakage into the receiving channel by adjusting the separation distance.

In some embodiments, the transmitting and receiving antennas 357 and 358 may be configured rotatable in the plane of the patch elements. The antennas 357 and 358 may be rotated such that the antenna radiation's nulls point to each other. It may reduce the leakage from the antenna 357 to the antenna 358 directly and thus reduce the noise and improve the sensitivity of the LFMCW radar 356. Optionally, mounting planes of the antennas 357 and 358 may be offset to further reduce the leakage via the antennas when the antenna's lowest nulls are not in the same plane.

FIG. 4 illustrates a diagram of an exemplary UAV 400 according to the present disclosure. The UAV 400 may include a MCU 401, a flight controller 402, a GPS 403, IMUs 404, a communication module 405, and batteries (not shown). The UAV 400 may also include propellers, rotors, and other parts that are not annotated in the figure. Similar to the UAV 350, the MCU 401 performs data processing, the flight controller 402 is responsible for the stable flight of the UAV 400, the IMUs 404 are used to measure flight dynamics, and the communication module 405 is used for communication tasks.

Further, an LFMCW radar 406 is mounted on the UAV 400. The LFMCW radar 406 may have low SWaP-C characteristics. In some embodiments, the structure of the LFMCW radar 406 may be the same as or similar to that of the LFMCW radar 100 as illustrated in FIG. 1. In some aspects, the structure of the LFMCW radar 406 may be similar to that of the LFMCW radar 356 as illustrated in FIG. 3. Like the radar 356, the LFMCW radar 406 has transmitting and receiving antennas 407 and 408. The antennas may be high-gain low-profile patch array antennas with patch elements 409 and 410 exemplarily. However, while the radar 356 does not have a servo motor that rotates its antennas, the LFMCW radar 406 contains a servo motor 411 that rotates antennas 407 and 408 simultaneously. The antennas may be rotated 360 degrees about the vertical axis by the servo motor 411, when the LFMCW radar 406 scans surrounding objects using radar signals. In some embodiments, the LFMCW radar 406 may have two servo motors, the servo motor 411 and another servo motor (not shown). The two servo motors may form a pan and tilt platform that may rotate the antennas 407 and 408 in a horizontal plane or in a vertical plane. Servo motor pan or tilt features may also be used to reduce ground clutter. Based on the flight yaw and pitch and saved antenna patterns, the motor may adjust the antennas' platforms so that antenna nulls may be pointed to the maximum of ground signals to minimize the ground clutter. For example, based on the flight height information (e.g., data received from the GPS 403) and ground maps as well as altitude measurement data, antenna radiation patterns, and UAV pitch, roll and yaw information, the system may dynamically adjust the tilting angles of the antennas' platforms to minimize the ground clutter by aligning the antenna nulls to the largest ground clutter. Besides the antennas and servo motor, other components of the radar 406 are not shown in the figure.

Similar to the LFMCW radars 100 and 356, the LFMCW radar 406 may produce an LFMCW signal. The LFMCW signal is split into a first portion and second portion that are sent to an upper converter and a mixer, respectively. The upper converter increases the frequency of the first portion by the IF to generate a radar signal. The radar signal is emitted by the transmitting antenna 407. The second portion of the LFMCW signal is used as a local oscillator signal for the mixer to mix with a reflected radar signal.

The reflected radar signal is received by the receiving antenna 408. Similar to the above-described methods for the radars 100 and 356, double conversions may be performed in the receiving channel using the mixer, an IQ demodulator, the local oscillator signal, and an IF signal. The LFMCW radar 406 may have a low-level noise floor in the receiving channel and high signal sensitivity.

Optionally, with methods similar to that described above, the orientation of and separation between the transmitting and receiving antennas 407 and 408 may be adjusted to reduce the noise and improve the sensitivity of the LFMCW radar 406.

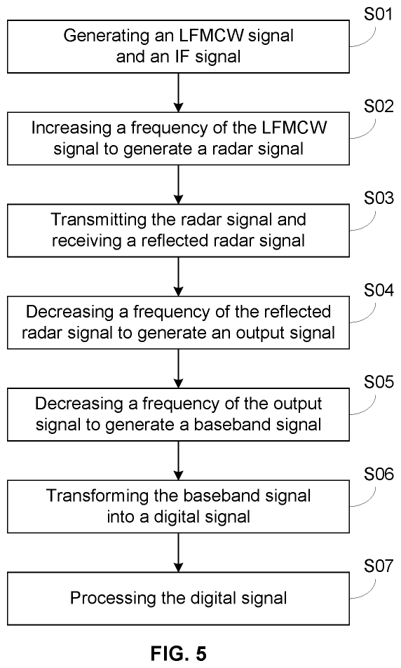

FIG. 5 shows a schematic flow chart to illustrate methods for an LFMCW radar according to the present disclosure. The LFMCW radar may be a low SWAP-C airborne radar and mounted on a small UAV to detect other UAVs. At S01, an LFMCW signal generator (e.g., the signal generator 101 as shown in FIG. 1) generates an LFMCW signal. The LFMCW signal may be divided into a first portion and a second portion by a power divider or directional coupler. A frequency synthesizer (e.g., the second frequency synthesizer 112 as shown in FIG. 1) generates a signal and a frequency divider processes the signal to produce an IF signal with the IF. The first portion of the LFMCW signal may be amplified by a first amplifier.

At S02, the amplified LFMCW signal and IF signal are inputted into an upper converter (e.g., the upper converter 104 as shown in FIG. 1). The upper converter increases the frequency of the amplified LFMCW signal by the IF to generate a radar signal. The radar signal may be amplified by a second amplifier and transmitted to a transmitting antenna.

At S03, the transmitting antenna emits the amplified radar signal and a receiving antenna receives a reflected radar signal from a target. The reflected radar signal may be filtered by a bandpass filter, amplified by a third amplifier, and then transmitted to a mixer (e.g., the first mixer 117 as shown in FIG. 1). The second portion of the LFMCW signal may be amplified and transmitted to the mixer as a local oscillator signal.

At S04, the mixer mixes the reflected radar signal and the local oscillator signal to perform down conversion. The mixer decreases the frequency of the reflected radar signal to generate an output signal. The output signal may be filtered by a narrowband filter with the IF as the center frequency. Further, the output signal may be amplified by a low noise IF amplifier and UHF amplifier.

At S05, the filtered and amplified output signal is transmitted to and inputted into an IQ demodulator (e.g., the IQ demodulator 122 as shown in FIG. 1). The frequency synthesizer produces another IF signal and transmits the other IF signal to the IQ demodulator. The IQ demodulator may contain amplifiers and mixers to amplify and down convert the inputted output signal. As such, the IQ demodulator decreases the frequency of the output signal to generate baseband signals. The baseband signals may be filtered by high-pass and low-pass filters. The low-pass filter may be adjustable or programmable, e.g., with an adjustable cutoff frequency.

At S06, the filtered baseband signals are transmitted to ADCs (e.g., the ADCs 133 and 134 as shown in FIG. 1). The ADCs transform the baseband signals into digital signals. At S07, the digital signals are transmitted to a micro controller (e.g., the micro controller 135 as shown in FIG. 1). The micro controller processes the inputted digital signals according to prearrangements.

With the same reasons as illustrated above, the low SwaP-C LFMCW radar may have high sensitivity. It may be used for air-to-ground and air-to-air detections. When flying with the UAV, the radar may approach and find other UAVs that may be hard to detect for conventional ground radars.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A radar system, comprising:
a linear frequency-modulated continuous-wave (LFMCW) signal generator for generating an LFMCW signal;
a frequency synthesizer;
a frequency reference for generating a reference signal and transmitting the reference signal to the frequency synthesizer;
a plurality of frequency dividers for respectively dividing a frequency produced by the frequency synthesizer to generate a first intermediate frequency (IF) signal and a second IF signal;
an upper converter for using the first IF signal to increase a frequency of the LFMCW signal to generate a radar signal, a frequency of the radar signal being a sum of a frequency of the LFMCW signal and the IF;
a transmitting antenna for transmitting the radar signal;
a receiving antenna for receiving a reflected radar signal;
a mixer for decreasing a frequency of the reflected radar signal to generate an output signal;
an IQ demodulator for using the second IF signal to decrease a frequency of the output signal to generate a baseband signal;
an analog-to-digital converter for transforming the baseband signal into a digital signal; and
a micro controller for processing the digital signal.

2. The system according to claim 1, further comprising:
a power splitting component for splitting the LFMCW signal into a first part and a second part, the first part being transmitted to the upper converter and the second part being transmitted to the mixer.

3. The system according to claim 1, further comprising:
another frequency divider for dividing the frequency produced by the frequency synthesizer to generate another IF signal, the other IF signal being transmitted to the IQ demodulator.

4. The system according to claim 1, further comprising:
a narrowband filter with a center frequency of the IF for filtering the output signal.

5. The system according to claim 1, further comprising:
an adjustable filter for filtering the baseband signal.

6. The system according to claim 1, wherein the transmitting antenna and receiving antenna include a Yagi antenna, helical antenna, horn antenna, or patch antenna.

7. The system according to claim 1, wherein the radar is mounted on an unmanned aerial vehicle (UAV).

8. A method for a radar, comprising:
generating a linear frequency-modulated continuous-wave (LFMCW) signal by an LFMCW signal generator;
generating an intermediate frequency (IF) signal using a frequency synthesizer;
increasing a frequency of the LFMCW signal to generate a radar signal by an upper converter, a frequency of the radar signal being a sum of a frequency of the LFMCW signal and the IF;
transmitting the radar signal by a transmitting antenna;
receiving a reflected radar signal by a receiving antenna;
decreasing a frequency of the reflected radar signal to generate an output signal by a mixer;
decreasing a frequency of the output signal to generate a baseband signal by an IQ demodulator;
transforming the baseband signal into a digital signal by an analog-to-digital converter; and
processing the digital signal by a micro controller.

9. The method according to claim 8, further comprising:
splitting the LFMCW signal into a first part and a second part by a power splitting component;
transmitting the first part to the upper converter; and
transmitting the second part to the mixer.

10. The method according to claim 9, further comprising:
before transmitting the first part of the LFMCW signal to the upper converter, amplifying the first part of the LFMCW signal by an amplifier.

11. The method according to claim 8, further comprising:
generating another IF signal using the frequency synthesizer; and
transmitting the other IF signal to the IQ demodulator.

12. The method according to claim 8, further comprising:
filtering the output signal by a narrowband filter with a center frequency of the IF.

13. The method according to claim 8, wherein the transmitting antenna and receiving antenna include a Yagi antenna, helical antenna, horn antenna, or patch antenna.

14. The method according to claim 8, further comprising:
filtering the baseband signal by an adjustable filter.

15. An unmanned aerial vehicle (UAV), comprising:
a flight controller;
a communication module;
a linear frequency-modulated continuous-wave (LFMCW) signal generator for generating an LFMCW signal;
an intermediate frequency (IF) signal generator for generate an IF signal;
an upper converter for increasing a frequency of the LFMCW signal to generate a radar signal, a frequency of the radar signal being a sum of a frequency of the LFMCW signal and the IF;
a transmitting antenna for transmitting the radar signal;
a receiving antenna for receiving a reflected radar signal;
a mixer for decreasing a frequency of the reflected radar signal to generate an output signal;
an IQ demodulator for decreasing a frequency of the output signal to generate a baseband signal;
an analog-to-digital converter for transforming the baseband signal into a digital signal; and
a micro controller for processing the digital signal.

16. The UAV according to claim 15, further comprising;
a power splitting component for splitting the LFMCW signal into a first part and a second part, the first part being transmitted to the upper converter and the second part being transmitted to the mixer.

17. The UAV according to claim 15, wherein the IF signal generator generates another IF signal that is transmitted to the IQ demodulator.

18. The UAV according to claim 15, further comprising;
a narrowband filter with a center frequency of the IF for filtering the output signal.

19. The UAV according to claim 15, further comprising;
an adjustable filter for filtering the baseband signal.

20. The UAV according to claim 15, wherein the transmitting antenna and receiving antenna include a Yagi antenna, helical antennas, horn antennas, or patch array antenna.
